(19) United States
(12) Patent Application Publication
(10) Pub. No.: US 2021/0209558 A1
(43) Pub. Date: Jul. 8, 2021

(54) System and Method for Recruitability Predictive Analysis

(71) Applicant: HumanPredictions Software Inc., McHenry, IL (US)

(72) Inventors: Daniel J. Barulli, Brooklyn, NY (US); John R. Hundrieser, McHenry, IL (US); Elliott G. Garms, Chicago, IL (US); Steven Oscar Giron, Chicago, IL (US)

(73) Assignee: HumanPredictions Software Inc., McHenry, IL (US)

(21) Appl. No.: 16/733,790

(22) Filed: Jan. 3, 2020

(51) Int. Cl. G06Q 10/10; G06N 7/00; G06N 20/20; G06N 5/00

(52) U.S. Cl. CPC G06Q 10/105; G06N 5/003; G06N 20/20; G06N 7/005

(57) ABSTRACT

A method for recruitability predictive analysis is provided with the steps of importing person data from a plurality of data sources including employee identity, past job history, current job information, and company information; selecting a plurality of optimized data models; storing the person's data in the plurality of optimized data models; nesting the plurality of optimized data models; analyzing the nested plurality of optimized data models; selecting at least one variable; and determining a probability that a person is likely to change jobs within a specified time period.

### CROSS-REFERENCE TO RELATED APPLICATIONS

The present application claims the benefit of provisional patent application Ser. No. 62/792,397, filed 2019 Jan. 14 by the present inventors, which is incorporated by reference in its entirety.

### TECHNICAL FIELD

The present disclosure relates to the field of predictive analytics, and in particular to a system and method for predictive modeling of recruitability amongst technical job-seekers.

### BACKGROUND ART

Recruiting in the technical industry has generally been performed by matching a person's technical skills with job requirements of a particular position. The technical skills of a person are reported on a resume, or a CV, which are generally stored and transmitted in an electronic format. Recruiters that are internal or external to a company that is seeking to fill an open job position can announce a need to fill a job position through electronic job boards. These types of announcements have the effect, in most industries, of attracting many applications for the open job position. Due to the high demand for technical skills, and a relatively low supply of technical workers, technical jobs often can be filled only sluggishly by announcing a job posting. People with technical skills who apply for the job position are the ones who are actively seeking employment. There is a high rate of incidence of people in this active position misrepresenting their qualifications for the job position in order to secure a job, which may not be in the best, long-term interests of the recruiter and the company. The recruiter risks their reputation for reliability in attracting accurately qualified candidates and the company risks loss of capital invested into recruiting and qualifying candidates for the open job position. It is widely felt in the technical recruiting industry that active job seekers tend to have a higher probability of being a less reliable and effective employee compared to their peers who are currently employed. The specific reason for a person to actively seek a job is generally unknown to a recruiter. However, it is widely assumed that the reason is at least some level of dissatisfaction of some sort, whether that dissatisfaction is on the part of the employer or the employee. People who are currently employed are generally viewed as stable satisfied employees, which is a desirable feature for both the employer and the employee.

Extensive research has been conducted into the phenomenon of employee attrition at particular organizations. Such research has focused on using available data sources, or designing new questionnaires and other research instruments to collect new data, in service of predicting which employees are at risk of leaving the organization. This is done to curb the costs associated with attrition, which stem from the extensive training and lost productivity that is brought about by replacing a more experienced employee, who is already familiar with the specifics of their organization and role, with a new employee.

Empirical studies conducted on employee attrition are consistent with this idea. Common factors associated with leaving a position include: dissatisfaction with compensation, the perception of unfairness in the workplace, agitation with management style, and dissatisfaction with the pace of advancing within the organization. A plurality of these variables together could act as a very strong predictor of employee attrition, and therefore a potential recruitment opportunity for a similar competitor.

Determining which stably-employed tech employees should be targeted for recruitment has traditionally required a laborious process of contacting prospective employees and beginning a continuous dialogue, often yielding very few successful candidates for the amount of recruiting effort expended.

### SUMMARY OF THE EMBODIMENTS

In accordance with one embodiment a system and method for recruitability predictive analysis comprises a set of periodically-refreshing webscraping scripts collecting data from public sources online pertinent to the daily activities of people in the tech sector, depositing collected data to a permanent storage space (e.g. a data lake), atop which is applied a predictive model based on empirical research into employee attrition which estimates pertinent factors related to i) the potential job-seeker, ii) the company at which they are employed, and iii) the particular job they occupy, and transforms these factors into predictions about that employee's level of recruitability within the short-term future.

Although each of the factors linked to employee attrition is difficult and time-consuming to measure, all of them have close correlates that are much easier to measure, and in many cases are publicly available. A vast amount of data on stably-employed tech employees is publicly available due to the advent of social and professional networking websites, to which such people often submit their personal and professional histories, and technical expertise. People often also contribute examples of their technical work (e.g. functioning code written in some programming language) to public repositories on particular platforms, both for the purpose of advancing open source projects and for demonstrating their competence in a specific technical language. Aggregating and structuring this disparate data for interpretation by recruiting professionals presents an opportunity to dramatically increase the efficiency of the recruiting process. Some embodiments provide a rapid process for recruiting qualified and highly desired stably-employed candidates to particular positions, taking advantage of various predictive models for mining, summarizing, and transforming these data until they match the factors needed to accurately predict when an individual employee may begin considering leaving their current position—and hence also predict when they would be most amenable to being recruited for a new one. Such an embodiment reduces the time required for recruiters to find an appropriate job applicant, and reduces the costs associated with the human labor of frequent correspondence with a multitude of potential employees.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. A fuller understanding of the foregoing may be had by reference to the accompanying drawings, wherein:

FIGS. 1 and 2 are flowcharts of a method for recruitability predictability analysis according to the teachings of the present disclosure;

FIG. 3 is a simplified block diagram of a system and method for recruitability predictability analysis according to the teachings of the present disclosure; and

FIGS. 4-9 are exemplary screenshots of a system and method for recruitability predictive analysis according to the teachings of the present disclosure.

### DETAILED DESCRIPTION OF SPECIFIC EMBODIMENTS

Described herein is a system and method that prioritizes potential candidates based on the their estimated “recruitability” to a new job, for use by employers looking to attract new talent as well as employers attempting to monitor their own employee attrition. The term “recruitability” is used to refer to an estimated measurement of a person's likelihood to change jobs at a certain point in time. The system and method make a prediction on recruitability based on a person's tenure at the current job and other factors. The candidates may be either passive (not currently looking for a new position) or active, but are predominantly passive and hence more highly desired by recruiters. In the tech recruiting industry, there is a need to identify passive potential job candidates with the actual technical skill set that is required for the current job opening and with a high potential for readiness to accept a job offer. The technical skill set of a potential candidate is often assessed through a resume or C.V. which can be posted through electronic means on a website such as LinkedIn. It is well known that simply listing a skill on a resume is a poor indicator of the sufficiency of that skill to fill a job requirement. The actuality and sufficiency of a skill can be inferred through other means such as discovering real-world technical experience and expertise on websites that publicly post interactions of a technical or expert nature. For example, GitHub is a collaborative software development platform that allows people with technical skills to contribute software, present the software for peer review, and to share accomplishments and contributions to software projects. A software such as humanpredictions.io can collect and interpret this data, which is very closely related to actual expertise and experience, and thereby more accurately infer the technical skills of potential job applicants.

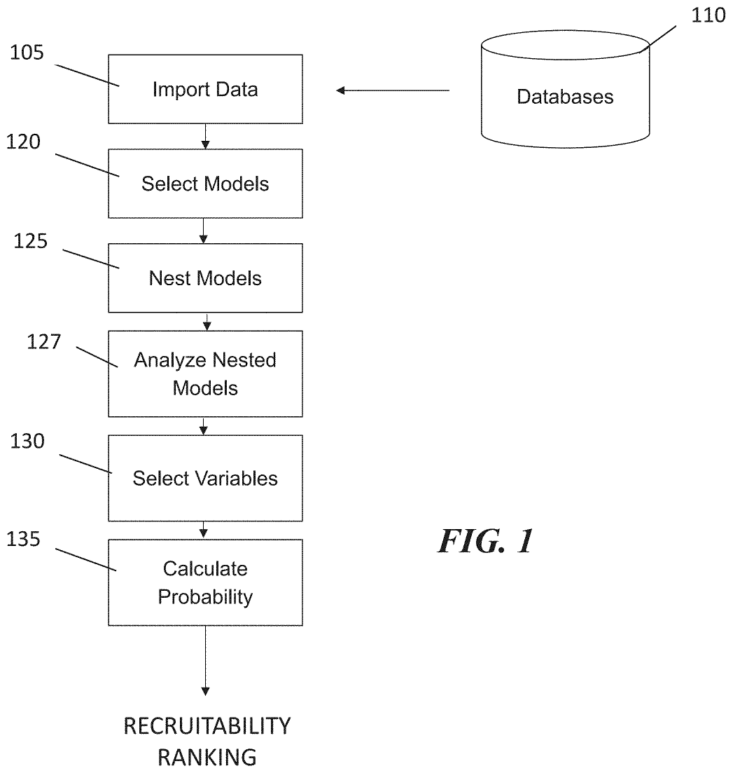

In reference to FIG. 1 there is shown an example of the scoring pipeline used to assess recruitability. As provided in Box 105, Import Data is received from a number of tables within our Databases 110. The Imported Data is assessed according to the data sources available for each particular individual, allowing our pipeline to Select Models 120 in order to best optimize the computed probability. Next the Nested Models 125 are embedded within a larger dataframe allowing a pre-trained algorithm to Analyze 127 and compute for each subportion of data the highest likelihood parameters for each Select Variables 130, dropping lowest-predictive variables and retaining the highest-predictive variables on a row-by-row basis. Finally, the model uses the selected variables to Calculate Probability 135 for each individual scored.

As a further example, StackOverflow is a publicly available website that serves as a platform for users to ask and answer questions, on a wide range of topics in computer programming. Through membership and active participation, users vote questions and answers up or down and edit questions and answers in a fashion. Users of StackOverflow can earn reputation points and badges which are representative of expertise on a topic.

The ability to determine the readiness to accept a job offer is not well known. The system and method described herein implement wisdom gained through traditional networking methods to improve that ability. It was discovered through traditional networking that people who are currently employed are many times more likely to be ready for a job change if they have been at their current company for approximately two years. Therefore, the system and method herein determine a ranking based on, in part, a scoring based on current tenure.

One aspect of the invention uses a person's employment history to predict whether a potential candidate will be ready to be recruited within a certain time frame. An employment history consists at a minimum of a job title, a company, a job start date, and a job end date. Analyzing trends in these employment data allows people to be classified into subgroups whose behavior is highly correlated with specific ranges of tenure (for instance, people holding titles such as “senior software engineers” at a large tech firm versus employees holding titles such as “intern” at a small startup). Various algorithms are available for finding such group classifications, as described below.

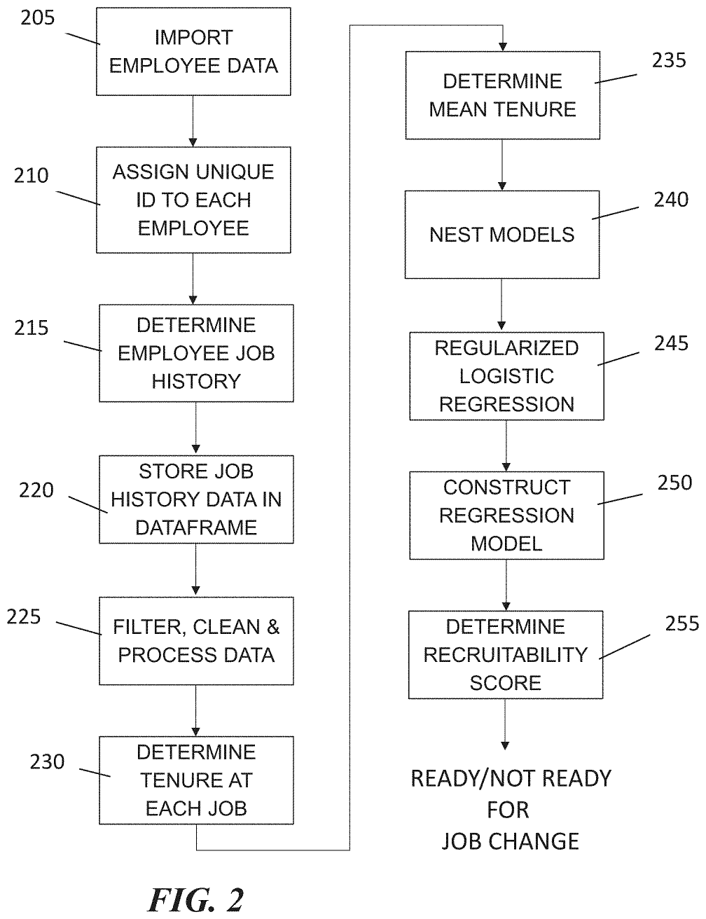

In reference to FIG. 2 there is shown one example instantiation of the data wrangling and manipulation process which occurs within the R computing environment. As seen in Box 205, R first Imports Employee Data into its memory, and Assigns Unique ID to Each Employee 210 which represents every unique person-job pair within the database. The ID is used to then collate and Determine Employee Job History (Box 215) by sequencing all person-job pairs in temporal order. These pairs are stored separately in an R dataframe within R's memory (Box 220) where they can be filtered, cleaned, and processed (Box 225) to remove obviously inaccurate data (e.g., where a job's end-date precedes its start-date, etc.). Each job's tenure is computed by subtracting the end-date of the position from its respective start-date (Box 230), providing the most important predictive variable in subsequent modeling. Mean tenure (Box 235) is then computed for each person, as well as each company, and each job title. These variables as well as others available are then nested according to the model nesting procedure described below (Box 240), allowing for each row an optimized sequence of algorithms to be applied, such as regularized logistic regression (Box 245) followed by a second regression model (Box 250), such as logistic regression, or a pre-trained random forest model to select the best-performing algorithm. This process results in a dichotomous label of ‘recruitable’ or ‘not recruitable’ for each row and current job, a recruitability score (Box 255). (A third intermediate label is applied to those profiles with insufficient data to be scored according to pre-trained models.)

Another aspect of the invention uses publicly available data from websites where people post information related to their company, job position, or work product. Such websites include but are not limited to: Chef Supermarket (DevOps), CocoaPods (iOS Developers), CodePen (Front-End Developers), Dribbble (Designers), Facebook, GitHub, Kaggle (Data Scientists), LinkedIn, Meetup, npmjs (Front-End Developers), NuGet (.NET Developers), Puppet Forge (DevOps), RubyGems (Ruby Developers), Security StackExchange (security-related), Server Fault (DevOps), Speaker Deck, SQA (Quality Assurance), and Twitter.

From each of these and similar sources of data, the system and method comprises a set of pipelines to extract pre-specified pieces of data, match them to appropriate mappings within a database (commonly, their associated ‘job’, ‘person’, or ‘company’), and store this data for the purposes of a) using the data for predictive purposes, and/or b) displaying the data along with the predicted recruitability scores to recruiters using the platform's end-user GUI.

The pipelines described consist of: API requests to each target site with an available API for the sharing of data; webscrapers dedicated to each site without dedicated APIs, written in an Open Source programming language (such as Ruby) to extract key pieces of data from the JavaScript/HTML of particular profile pages for each person in our system; a centralized relational database to store these data and link them to their associated ids (e.g., a PostgreSQL database hosted either locally or via cloud storage servers); a set of ad hoc data cleaning scripts again written using some Open Source programming languages for continuously improving the quality and accuracy of the collected data; and a predictive model applied using statistical software (e.g. the Open Source statistical programming language “R”) that reads in these data, transforms them until they resemble the set of factors associated empirically with employee attrition, and then applies an algorithm or set of algorithms to the transformed factors in order to produce a recruitability score for each individual person.

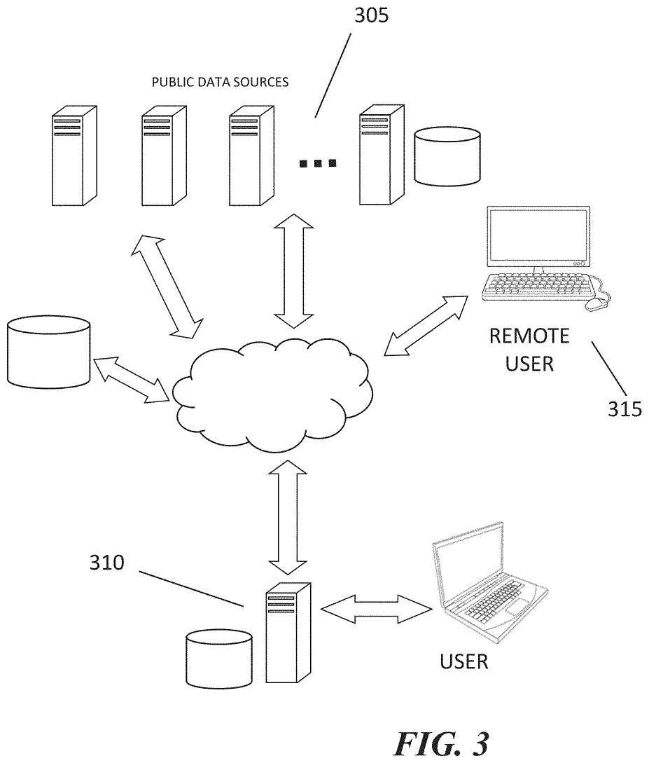

In reference to FIG. 3 there is shown a diagram of the entire general system architecture. Publicly available data sources (Box 305) distributed across the web are scraped into structured tables that are stored within a SQL database hosted on cloud servers (Box 310). The data can then be queried in a user-friendly manner using the online portal by any remote user with a human predictions subscription (Box 315).

The structure of the predictive model optimizes the application of algorithms to particular portions of the input data. Activities on social media sites, such as changes or updates made to social media profile information, GitHub repository insertions or deletions (e.g., beyond a certain predetermined threshold or person-specific baseline threshold), StackExchange activity, or new Meetup membership, can be observed for large spikes in activity thought to reflect a desire to expand one's professional network and/or to “clean up” the employee's current online profile, and a ranking system based on that employee's activity relative to their baseline activity is used to demarcate between normal and potentially significant online behavior. In the case of text information, such as Twitter updates, Text Mining and Sentiment Analysis are utilized to a) filter career-related text behavior from non-career related text behavior, and b) estimate the employee's sentiments both specifically about their career and vis-a-vis overall trends which may suggest a growing dissatisfaction. Following the individual treatment of each of these factors, the system allows their combination via machine learning classification techniques (including such algorithms as Regularized Logistic Regression or more advanced Deep Learning approaches entailing the training of artificial neural networks). For simple historical data such as an employee's past tenure history for example, Survival Analysis methods might be applied to find the expected current tenure in order to approximate the timeframe in which employees may become less than satisfied with their current position. However these estimates might be further refined with the inclusion of seasonality curves via Time Series analysis, which can modify the estimated or expected duration based on other factors endemic to seasonality (e.g. holidays, employment anniversaries, or broader economic employment trends). To accommodate nominal sources of data, such as company names which can often be uninformative due to the high number of small companies observed, Multiple Correspondence Analysis could be used to correlate the variance of such indicators with the variance provided by other nominal variables such as employee title. Cluster Analysis then might used to allow each company-title pair to be grouped according to the expected tenure, thus providing a factor to be used in subsequent analysis. All of these algorithms are encompassed and saved as functions within the process, and can each be individually nested as a model to be applied to the same sample set of data from the database.

The major insight in this approach relates to the particular treatment of the individual factors, as these models are each nested into a dataframe before the machine learning takes place, effectively allowing the process of variable selection (the automatic detection of relevant predictors) to operate across the individual models. This process assumes a high plurality in decision making about job attrition and allows the data to incorporate the optimized models about any individual factor for which we have high confidence (e.g. tenure curves for particular positions) while still dropping these models and improving predictivity when they are not informative for a particular individual. The practical benefit of these nestings is the reduction in labor needed on the part of the predictive analyst applying the algorithms in order to test which models are most appropriate, which varies dramatically both across groups of individuals and companies, and across time. Effectively instead the optimal model is selected automatically by a broader algorithm in the same manner that variables are selected within many machine learning models.

Referring to the figures, the system and method periodically collect and extract data from public websites. The collected data are stored in a secure local or remote database. The following tasks: importing new people and periodically refreshing profiles and activities (from sites such as Behance.net, StackOverflow.com, GitHub.com, About.Me, bintray.com, cocoapods.org, dribbble.com, meetup.com, libraries.io, npmjs.com, nuget.org), including data on the employee's job title, job start date, company, location, gender, age, educational credentials, interests, personal bio, assessed skills, (on sites with contributed code such as GitHub, or reputation badges such as StackOverflow), diversity status, and others.

The employment data is first imported from the secure local or remote database. The minimum effective subset of data includes the unique person ID assigned to each candidate in the database, the start-date at a particular position (with each row representing a specific position), the end-date at that position, the title at that position, and the company's name. All of these data are stored in a dataframe, which is a two-dimensional size-mutable, potentially heterogeneous tabular data structure with labeled axes (rows and columns). Arithmetic operations align on both row and column labels in the dataframe. The use of dataframes instead of using spreadsheets, linear data, etc. allows several innovative prediction techniques to be applied to the data, including data reduction methods and model nesting.

Other additional factors may include industry retention trends, retention trends at current company title of current position, approaching job anniversaries, and explicit indicators such as an person checking the box on their GitHub profile labeled as “Available for Hire” (known as the GitHub hirable flag) and thereby expressing receptivity to a new professional position.

Because data collection from the public websites is done frequently, the current set of data can be compared to the data set collected previously to identify those persons whose data have undergone substantial changes and revisions, which may point to resume and portfolio editing and updating activities that typically precede job hunting or a desire to change jobs. Such data comprises an entirely distinct predictive factor: employee behavior. This factor is distinct from the tenure history of the person and the company, and displays high predictive accuracy towards recruitability but also high variability (i.e. such behavior is highly predictive of tacit job seeking for some individuals but not others, again making the nested training approach advantageous).

The embodiment described herein uses an exemplary open-source statistical programming language R. R is a language that provides a wide variety of statistical (linear and nonlinear modelling, classical statistical tests, time-series analysis, classification, clustering, . . . ) and graphical techniques, and is highly extensible. R has an integrated suite of software facilities for data manipulation, calculation and graphical display. It includes an effective data handling and storage facility, a suite of operators for calculations on arrays, in particular matrices, a large, coherent, integrated collection of intermediate tools for data analysis, graphical facilities for data analysis and display either on-screen or on hardcopy, and a well-developed, simple and effective programming language which includes conditionals, loops, user-defined recursive functions and input and output facilities.

The imported data are first filtered, cleaned, and processed so that they are usable. R provides several base commands that allow data to be selected (e.g., columns chosen), filtered (e.g., rows matching some conditional value excluded), and omitted (e.g., missing data of the form “na” in the dataframe is removed). The dates in the dataframe are reformatted into separate columns for month-day and for year for both start-date and end-date. The data is filtered to exclude null values, and any duplicate rows are removed from the dataset. Next the data is further filtered to exclude all person rows where the end-date precedes the start-date (indicating error), then filtered to exclude all person rows where the start-date occurred before Jan. 1, 2000 to reduce noise associated with employment data that is too old to be predictive or relevant to the current inquiry. All job records where either the start-date or the end-date is recorded as January 1—are also removed, since these are of questionable accuracy due to possibly perfunctory data entry on the user's part. Further, company names are examined and standardized to remove minor variations. For example, the collected data may reference “ABC Engineering and Manufacturing” when the legal name of the company is “ABC Engineering and Manufacturing Inc.” Another advantage of this particular embodiment is that much of the necessary preprocessing conducted on unstructured text data such as job titles, company names, etc., can be computed in bulk for the entire database, saved within its own table, and referenced where necessary within the R environment. This allows each raw company name to be saved along with its standardized form, a standardized but often abbreviated ‘search key’ for end-users to employ, as well as other pieces of info pertinent to that particular company (e.g. stock ticker symbols for tracking financial news).

Thereafter, a numerical tenure value (in number of days) at each position in each person's job history is determined by subtracting the start date from the end date. The person's current position is indicated by a position with the latest start date but no end date. Next, the analysis determines whether some of the positions for the people are essentially the same job but with different titles. For example, “software programmer,” “software developer,” and “software coder” are essentially the same job. A basic unsupervised (k-means) cluster analysis is performed to lump job titles that map to similar jobs. The mean tenure for each cluster of similar job is then computed. Multiple correspondence analysis is also performed on the company name vector within the dataframe to determine categorical values for each company name based on the frequency of title clusters corresponding to each unique company value. This step provides insight into potential trends for each company. The mean tenure for each position and cluster, as well as the company value are stored in the dataframe.

The tenure of each individual person-job pair is transformed into a time series object, where it is de-seasonalized in order to model the effects on it of a variety of other variables, including changes in recent online activity (e.g. to GitHub, StackOverflow, or Meetup profiles), shifts in sentiment scores derived from sites like Twitter, job anniversaries, changes to company evaluation, etc. Each of these variables in turn can be incorporated into the prediction of the current tenure, and hence indicate when the person-job pair may be close to severing.

Next, each individual model used above is nested within the working dataframe using, for example, R's “tidyverse” and “modelr” packages. The nesting process is where the output from one model serves as the input to subsequent models. For instance, a model and subsetted dataframe of predicted tenure based solely on a person's history (representing very particular idiographic factors contributing to their tenure) may be included as a column within a larger dataframe to which broader models are applied (e.g. ones using idiographic as well as industry-specific factors to determine predicted tenure). Such a nested structure of increasingly complex models of tenure, combined with appropriate variable selection techniques (or in this case, model selection techniques—since models themselves are being stored as distinct variables at the highest levels of nesting) provides a method of optimizing predictions from the ground-up. In theory this practice is considered statistically unsound, since it is often employed haphazardly and using the same data repeatedly, however with appropriate partitioning of training from testing datasets at each level of modeling; since the available data are abundant, this setup allows each model to have enough power and simultaneously avoid overfitting of model parameters.

To take advantage of this nesting procedure, the system and method specify a general model function for each particular predictor and map this model onto the nested dataframe using a software function such as R's “purrr” package. The general model function can apply any model previously trained by the data, and these models are each tested to ensure that they a) increase the predictive power of the model above chance, and b) increase the predictive power of the entire super-model.

The dataframe, including several levels of nested models, is then used as the basis for machine learning, for instance in the form of a Random Forest algorithm, with feature mapping customized such that each model serves as an optimization-ready parameter within the global script. The feature mapping code provides a function for any new piece of data to be algorithmically manipulated based on 1) the chosen models and 2) the chosen outputs based on testing. In this way, each new piece of data is processed in a way that may be very different from a nearly identical piece of data (or, vice versa, two extremely dissimilar pieces of data may in theory be processed in a very similar manner).

A specific embodiment of the Random Forest model itself might be conducted using R's “caret” package, for example, wherein again a training set of the data is partitioned, and dichotomous outcomes corresponding to “looking for work” or “not looking for work” are computed for each person-id. The unused data, or the testing set, is used to compare the performance of these predictions with actual recorded observations of an individual ‘looking for employment’—i.e., someone who has been recorded as actually switching jobs in a short period subsequent to their being labeled “looking for work” (which may vary between, e.g., 1, 3, or 6 months) depending on the urgency of the end-user's recruitment needs and tolerance for false positives. The end result is a predicted tenure for the person's current job or a score that is indicative of the likelihood that the person is “ripe” for recruiting, i.e., recruitability.

After predictions are generated for each person-job pair available within our database, the results are color-coded for ease of interpretability, and those individuals predicted as highly-recruitable are flagged within our system to make them the priority search results for any recruiter searching for terms matching their attributes (be it ‘title’, ‘skills’, ‘seniority’, etc.). Those predicted as likely not recruitable are conversely deprioritized within the search results.

The significance of the nested model selection approach lies in its improvements to predictive accuracy over more traditional chum prediction models, and also in the fact that to the knowledge of the inventors no other recruiting tools use such models in prediction on publicly-collected data.

In a comparison using Sensitivity Analysis of this newer approach with a more standard approach (which often operated only in ‘additive’ ways, with each new indicator weighing into an overall recruitability score based on arbitrary choices among recruiters and designers of recruiting tools), the nested model selection yielded a ‘sensitivity’ of 0.711, a ‘specificity’ of 0.867, providing an overall mean accuracy of 0.844. Other configurations of nested models are also within the scope of the invention, which may sacrifice overall mean accuracy while being optimized for speed of operation, for example. In particular, such models can be deliberately biased with weighted parameters in order to preference either specificity (leading to fewer “false alarms” in the form of people incorrectly labeled as recruitable) or sensitivity (leading to high numbers of false alarms but fewer “misses/false negatives”—i.e., people being labeled as non-recruitable when in fact they were).

For each data source, multiple types of data are collected; and for each data point available for each person/job pair within our database, selection of the ideal algorithm by hand is likely to be a dynamic and suboptimized process. Nesting of the model choices within a larger model in the way described allows our system to employ a Random Forest algorithm to select not only the correct parameters within a fixed model, but it dynamically allows us to choose the best nested model parameters as well, thereby eliminating the need for constant individual testing for each particular piece of information/model feature.

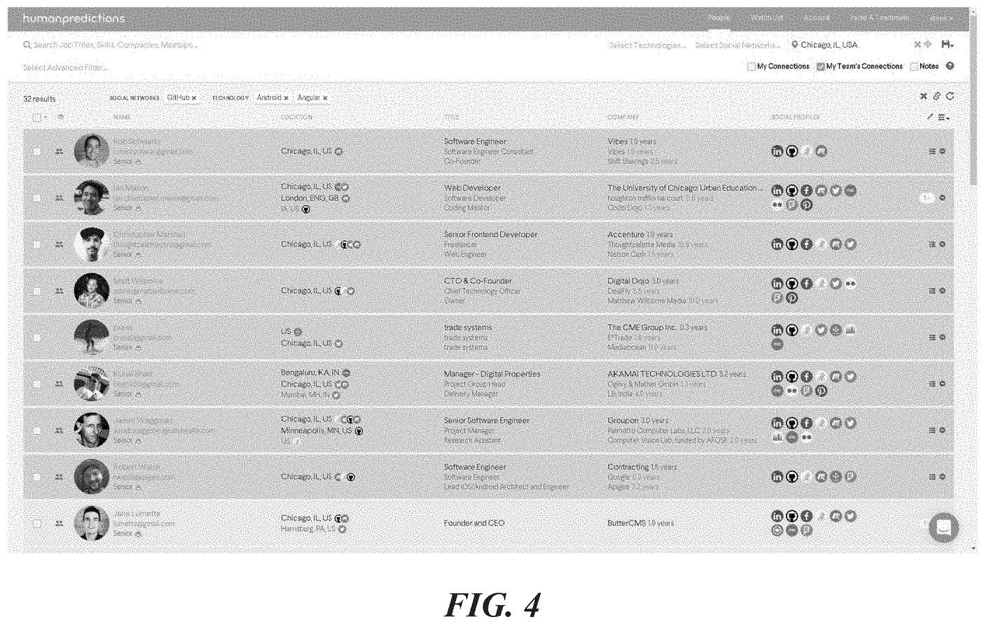

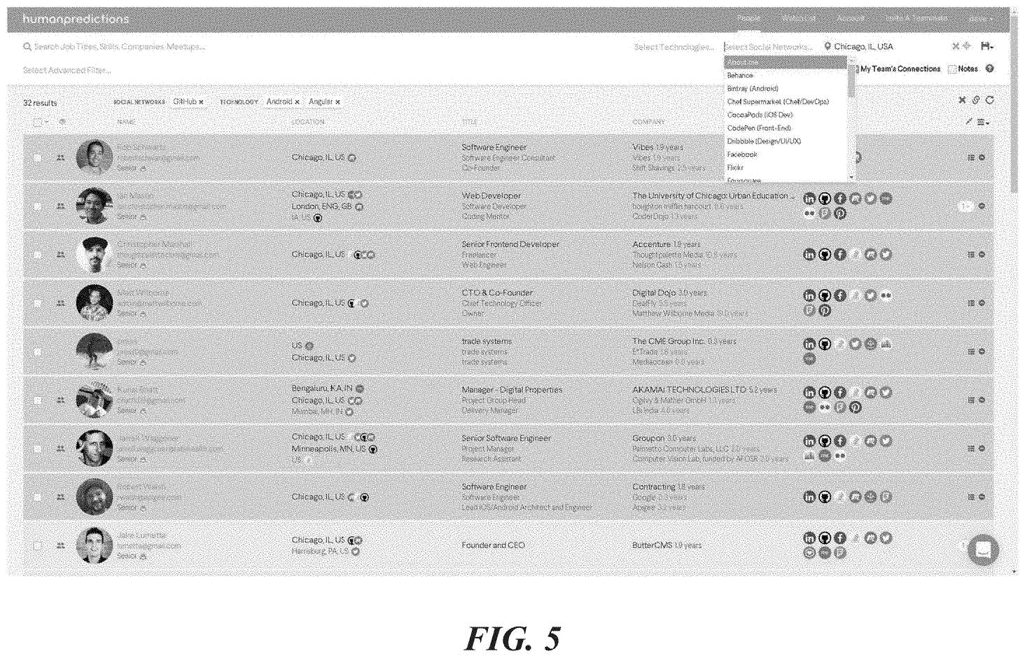

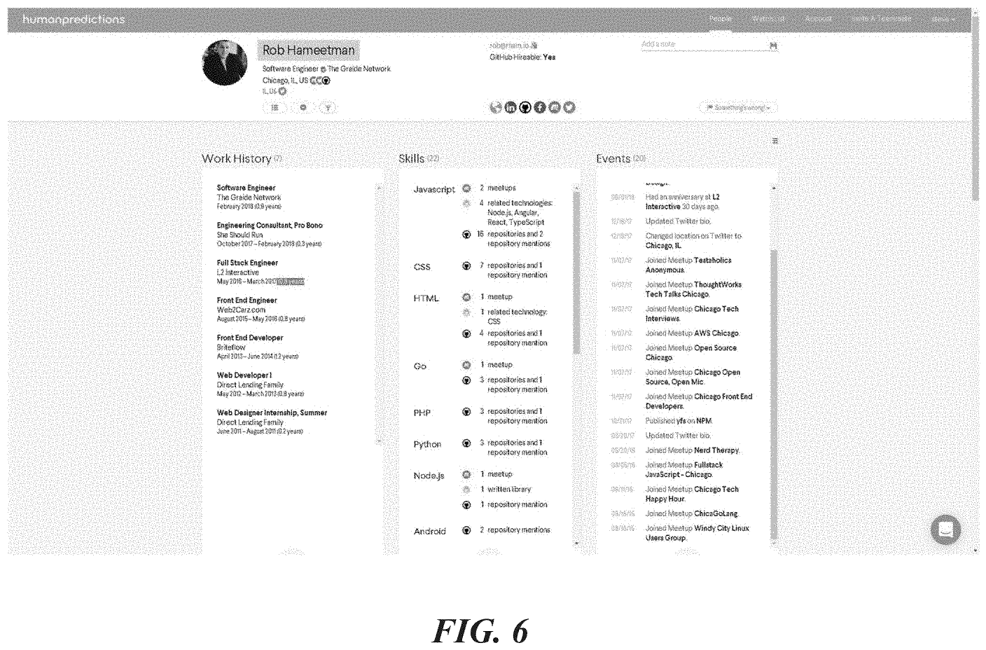

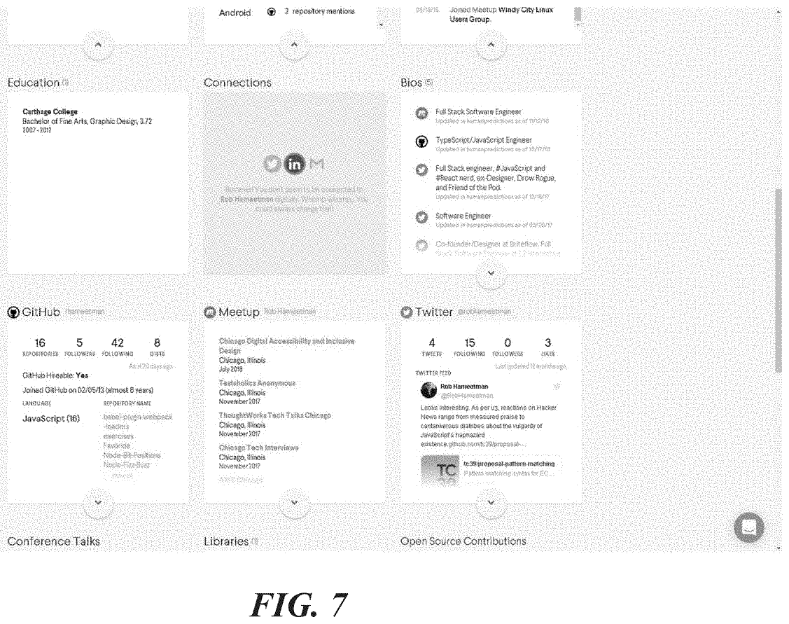

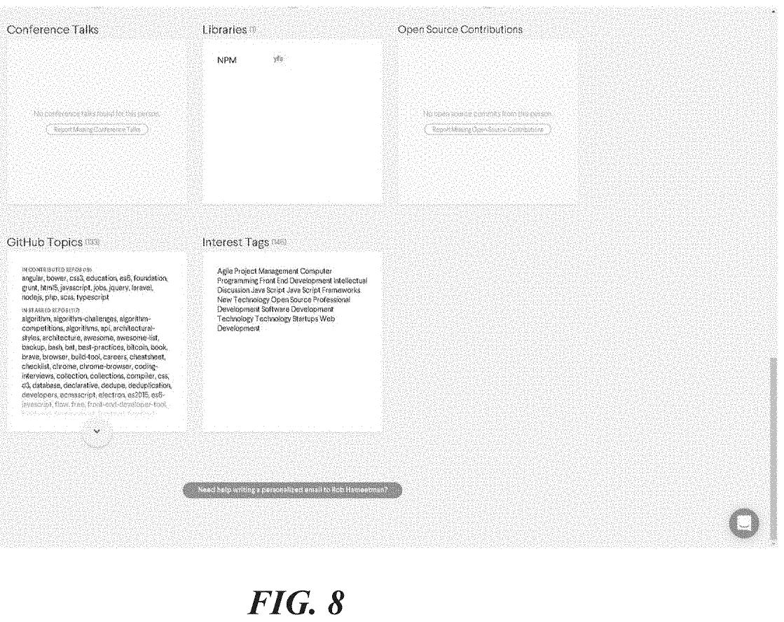

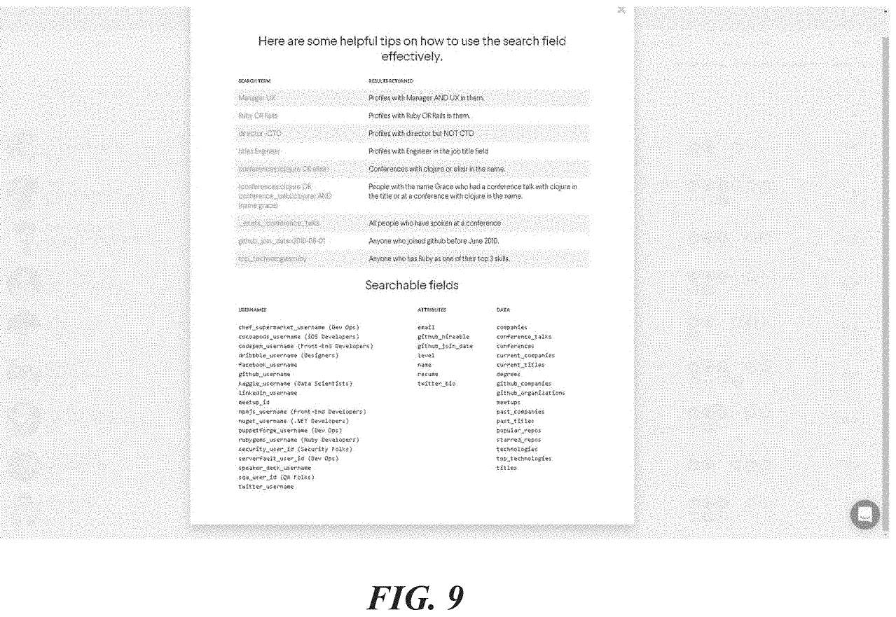

FIGS. 4-9 are representative exemplary screenshots of the system and method for recruitability predictive analysis. A listing of potential candidates are displayed, showing their names, photograph, geographical location (e.g., city, state, country), job title, company name, technical skills, and social profile links. The listing may display a prioritized list of candidates who are most susceptible to be open to the notion of a new position at a new company. The listing can be filtered according to location, social network/site presence, technology, job titles, skillset, etc. FIGS. 6-8 show more detailed information about a certain candidate, once she/he/they are selected. The detailed information includes work history, skill set, recent events and activities, education, social network connections, online biographies, professional activities (articles, papers, and presentations), software code deposited in libraries, and topics and tags of interest. Aside from using the filters, the list of candidates can also be searched using search terms, such as the user instructions shown in FIG. 9.

The features of the present system which are believed to be novel are set forth below with particularity in the appended claims. However, modifications, variations, and changes to the exemplary embodiments described above will be apparent to those skilled in the art, and the system and method for recruitability predictive analysis described herein thus encompasses such modifications, variations, and changes and are not limited to the specific embodiments described herein.

We claim:

1. A method for recruitability predictive analysis comprising:
importing person data from a plurality of data sources including employee identity, past job history, current job information, and company information;
selecting a plurality of optimized data models;
storing the person's data in the plurality of optimized data models;
nesting the plurality of optimized data models;
analyzing the nested plurality of optimized data models;
selecting at least one variable; and
determining a probability that a person is likely to change jobs within a specified time period.

2. The method of claim 1, further comprising filtering and cleaning the imported person data.

3. The method of claim 1, further comprising computing a tenure for each job in the past job history.

4. The method of claim 1, further comprising computing a mean tenure for all jobs in the past job history.

5. The method of claim 1, further comprising determining a probability score that the person is likely to change jobs within a specified time period.

6. The method of claim 1, wherein one of the plurality of optimized data models includes a multiple correspondence analysis.

7. The method of claim 1, wherein the person's past job history comprises a job title, a start date, an end date, and a company name.

8. The method of claim 1, wherein analyzing the nested plurality of optimized data models comprises a regularized logistic regression.

8. The method of claim 1, wherein analyzing the nested plurality of optimized data models comprises a k-means cluster analysis.

9. The method of claim 1, wherein determining a probability that an person is likely to change jobs comprises determining a likelihood of job change within one month, three months, and six months.

10. The method of claim 1, further comprising determining a tenure for all similar jobs in the past job history.

11. The method of claim 1, further comprising presenting a searchable and filterable ranked list of candidates according to recruitability.

12. The method of claim 1, further comprising the use of Random Forest algorithms to determine optimized parameters not just for predicted results, but also for hierarchical model nestings.
